(19) United States
(12) Patent Application Publication
(10) Pub. No.: US 2013/0260663 A1
(43) Pub. Date: Oct. 3, 2013

(54) VEHICULAR AIR CONDITIONER AND ASSEMBLY METHOD THEREFOR

(71) Applicant: KEIHIN CORPORATION, Tokyo (JP)

(72) Inventors: Koichi Kaiyama, Utsunomiya-shi (JP); Hiroharu Takahashi, Kawachi-gun (JP); Yoshiomi Ito, Kuki-shi (JP)

(73) Assignee: KEIHIN CORPORATION, Tokyo (JP)

(21) Appl. No.: 13/841,190

(22) Filed: Mar. 15, 2013

(30) Foreign Application Priority Data
Mar. 27, 2012 (JP) 2012-070914

(51) Int. Cl. B60H 1/00

(52) U.S. Cl. CPC B60H 1/00457
USPC 454/155; 29/428

(57) ABSTRACT

An air mixing damper, which is displaceable in a direction substantially perpendicular to an air flow direction, is disposed between an evaporator and a heater core in a casing that constitutes a vehicular air conditioner. In the air mixing damper, a plurality of ribs are formed so as to project on a side of a dividing wall that divides an air flow passage, and rack gears, which are enmeshed with a shaft, are formed on an inner circumferential surface on the opposite side thereof. In addition, when the air mixing damper is assembled in the casing, in a condition in which the ribs are in abutment against a sealing surface of the dividing wall, pinion gears of the shaft are enmeshed with the rack gears, whereby jostling of the air mixing damper is prevented.

### CROSS-REFERENCE TO RELATED APPLICATION

This application is based upon and claims the benefit of priority from Japanese Patent Application No. 2012-070914 filed on Mar. 27, 2012, the contents of which are incorporated herein by reference.

### BACKGROUND OF THE INVENTION

1. Field of the Invention

The present invention relates to a vehicular air conditioner, which is mounted in a vehicle, and by which air, which has been adjusted in temperature by a heat exchanger, is blown into a vehicle cabin to thereby carry out air conditioning inside the vehicle cabin. The present invention also concerns an assembly method for such a vehicular air conditioner.

2. Description of the Related Art

Heretofore, a vehicular air conditioner, which is installed in a vehicle, takes in interior and exterior air by a fan into an air flow passage formed in an interior portion of a casing, and after mixing chilled air, which is cooled by an evaporator type of cooling means, and heated air, which is heated by a heater core type of heating means, inside the casing at a desired mixing ratio, the mixed air is made to pass through a plurality of openings disposed in the casing and through a blowing duct, and is blown out from an outlet disposed in the vehicle cabin, whereby adjustment of temperature and humidity is carried out in the interior of the vehicle cabin.

The present applicant, as disclosed in Japanese Laid-Open Patent Publication No. 2011-057044 (Patent Document 1), has proposed a slide damper device equipped with a slide damper, which is slidably displaceable along a guide rail provided in the interior of a case. With the side damper device, by sliding the slide damper under a driving action of a driving device, the opening area of plural flow paths disposed on a downstream side of the slide damper is adjusted, whereby it is possible to adjust the flow rate or flow through state of air that flows from the case to the flow paths.

Further, in a vehicular air conditioner according to Japanese Laid-Open Patent Publication No. 2001-097024 (Patent Document 2), a pair of cases is formed in a dividable fashion, and a mixing door, which is capable of being slidably displaced, is arranged in the interior of the cases between an evaporator and a heater core. In addition, air that is adjusted in temperature inside the cases supplied to a downstream side at a desired flow rate through operation of the mixing door. The mixing door is constructed as a unit by installing in a door housing a mixing door main body and a slide mechanism for slidably displacing the mixing door main body.

### SUMMARY OF THE INVENTION

However, for example, in the event that the slide damper device according to the aforementioned Patent Document 1 is applied to a vehicular air conditioner having two divided casings, in a condition in which the slide damper is assembled into one of the divided casings, although the other divided casing can be assembled thereon, it is difficult for assembly to be carried out with good efficiency due to backlash or jostling of the slide damper.

Further, in the case that a slidably displaceable mixing door main body is assembled with respect to a pair of divided casings, as in the vehicular air conditioner of the aforementioned Patent Document 2, in a state in which the mixing door main body is assembled on one of the divided casings, it becomes difficult to assemble the other divided casing thereon, leading to a deterioration in the ease of assembly thereof. On the other hand, in the case that the mixing door is constructed as a unit including a mixing door main body, although ease of assembly with respect to the cases can be improved, conversely, the number of parts is increased accompanied by an increase in the weight of the apparatus.

A general object of the present invention is to provide a vehicular air conditioner and an assembly method therefor, which by means of a simple structure, enables a slide damper to be assembled reliably and efficiently with respect to a casing having a divided configuration.

The present invention is characterized by a vehicular air conditioner including a casing having an air flow passage in an interior thereof, and a slide mechanism disposed movably in the interior of the casing, for switching a communication state of the air flow passage by moving in a direction to block the air flow passage.

The casing is formed in a dividable fashion in a lateral direction perpendicular to a displacement direction of the slide mechanism. The casing comprises a guide member that engages with the slide mechanism for guiding the slide mechanism, and a seat section that abuts against a downstream side of the slide mechanism for blocking communication between upstream and downstream sides of the air flow passage.

The slide mechanism comprises a door main body that blocks the air flow passage by abutment against the seat section, a shaft disposed rotatably in the casing and which is disposed on an upstream side of the door main body for thereby driving the door main body, and an engagement member, which is disposed on a lateral end portion on the door main body, and is engaged with the guide member.

At least one of the guide member and the engagement member includes a correcting member for correcting an inclination of the door main body toward a seal member to a proper position.

According to the present invention, when the slide mechanism is assembled with respect to a divided one of the casings, the shaft that is fixed in an upstanding manner, and a door main body of the slide mechanism are retained by the side of the seat section, whereby falling over of the door main body by more than a specified amount with respect to the casing is prevented. Further, by providing the correcting member in the guide member and/or the engagement member for correcting the inclination of the door main body to a proper position, even in a state in which the door main body is slightly inclined, through assembly of the casing, the door main body is forcibly corrected to a proper position. As a result, when the other casing is assembled with respect to the one casing in which the slide mechanism is installed, it is unnecessary for a worker to carry out the assembly operation while supporting the slide mechanism, and thus it is possible, with a simple structure, to carry out the assembly operation reliably and efficiently.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a side view of a casing in a vehicular air conditioner according to an embodiment of the present invention;

FIG. 2 is a cross sectional view taken along line II-II of FIG. 1;

FIG. 3A is an exterior perspective view of an air mixing damper constituting part of the vehicular air conditioner of FIG. 1;

FIG. 3B is an exterior perspective view of an air mixing damper according to a modified example;

FIG. 4 is a cross sectional view for explaining a case in which the air mixing damper of FIG. 3A is assembled in the interior of first and second divided casings;

FIG. 5A is an enlarged cross sectional view showing the vicinity of a guide groove and a guide member of a vehicular air conditioner according to a first modification;

FIG. 5B is an enlarged cross sectional view showing the vicinity of a guide groove and a guide member of a vehicular air conditioner according to a second modification;

FIG. 5C is an enlarged cross sectional view showing the vicinity of a guide groove and a guide member of a vehicular air conditioner according to a third modification;

FIG. 5D is an enlarged cross sectional view showing the vicinity of a guide groove and a guide member of a vehicular air conditioner according to a fourth modification; and

FIG. 5E is an enlarged cross sectional view showing the vicinity of a guide groove and a guide member of a vehicular air conditioner according to a fifth modification.

### DETAILED DESCRIPTION OF THE PREFERRED EMBODIMENTS

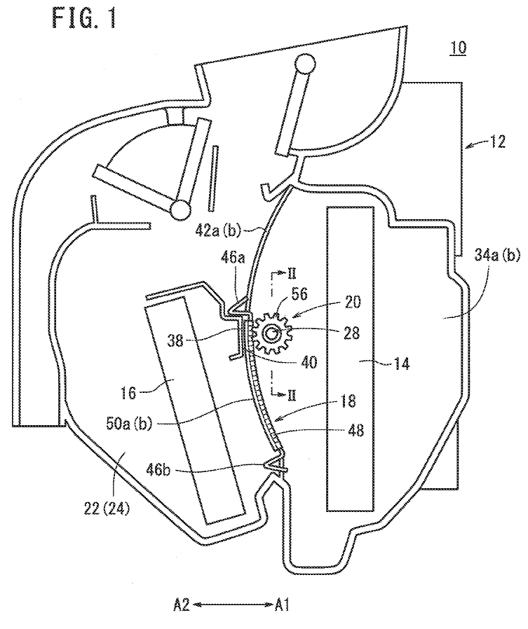

As shown in FIG. 1, a vehicular air conditioner 10 includes a casing 12 that makes up respective air flow passages, an evaporator 14 arranged in the interior of the casing 12 for cooling air, a heater core 16 for heating the air, an air mixing damper (slide mechanism, slide damper) 18 by which heat exchange is carried out by the evaporator 14 and the heater core 16 on air that is directed into the interior of the casing 12, and which creates mixed air by mixing at a predetermined mixing ratio cool air and heated air that have been adjusted in temperature, and a driving force transmission mechanism 20 that transfers a driving force of a drive source (not shown) disposed on a side surface of the casing 12 to the air mixing damper 18 for effecting rotary displacement thereon.

The casing 12 is made up of first and second substantially symmetrically shaped divided casings 22 and 24. In an opening, which opens on a side portion of the first divided casing 22, a duct (not shown) is mounted through which air is introduced to the interior of the casing 12 by a non-illustrated fan.

Further, the evaporator 14 is disposed in the interior of the casing 12 at a position on an upstream side (in the direction of the arrow A1) of the air flow direction, whereas the heater core 16 is disposed at a position on a downstream side (in the direction of the arrow A2) with respect to the evaporator 14. Between the evaporator 14 and the heater core 16, the air mixing damper 18 is disposed for adjusting the flow rate and flow through state of air that is cooled by the evaporator 14 at a time that the air is made to flow downstream in the interior of the casing 12.

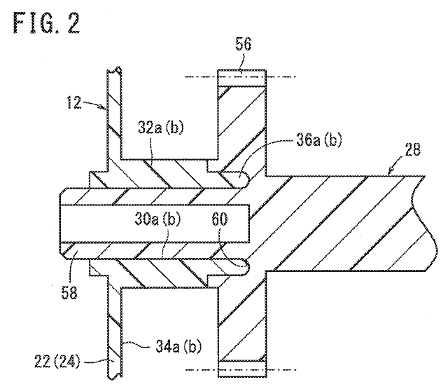

Furthermore, in the casing 12, at a position on the upstream side (in the direction of the arrow A1) with respect to the air mixing damper 18, a shaft 28, to which the driving force of the non-illustrated drive source is transmitted, is disposed rotatably for displacing the air mixing damper 18. As shown in FIG. 2, insertion holes 30a, 30b are formed respectively on inner wall surfaces 34a, 34b of the first and second divided casings 22, 24, substantially perpendicular to the air flow direction (the direction of arrows A1, A2). Both ends of the later described shaft 28 are inserted respectively through the insertion holes 30a, 30b.

Cylindrically shaped first tubular members 32a, 32b are formed on the outer peripheral sides of the insertion holes 30a, 30b so as to project from the inner wall surfaces 34a, 34b. On distal end portions thereof, small diameter parts 36a, 36b are formed, the outer circumferential surfaces of which are reduced in diameter radially inwardly.

On the other hand, as shown in FIG. 1, in the casing 12, at a position on the downstream side (in the direction of the arrow A2) with respect to the air mixing damper 18, a dividing wall (seat section) 38 is disposed, against which later described seal members 46a, 46b of the air mixing damper 18 come into abutment (contact). The dividing wall 38 divides the air flow passage. The dividing wall 38 is disposed in confronting relation to the shaft 28 provided in the casing 12, and includes a sealing surface 40 that faces toward the shaft 28 and the air mixing damper 18. Additionally, later described ribs 50a, 50b of the air mixing damper 18 are arranged so as to be capable of sliding along the sealing surface 40.

In the first and second divided casings 22, 24, a pair of guide members (correcting members) 42a, 42b, which act to guide the air mixing damper 18 upon displacement thereof, are formed on the inner wall surfaces 34a, 34b, which are substantially perpendicular to the air flow direction (the direction of the arrow A2).

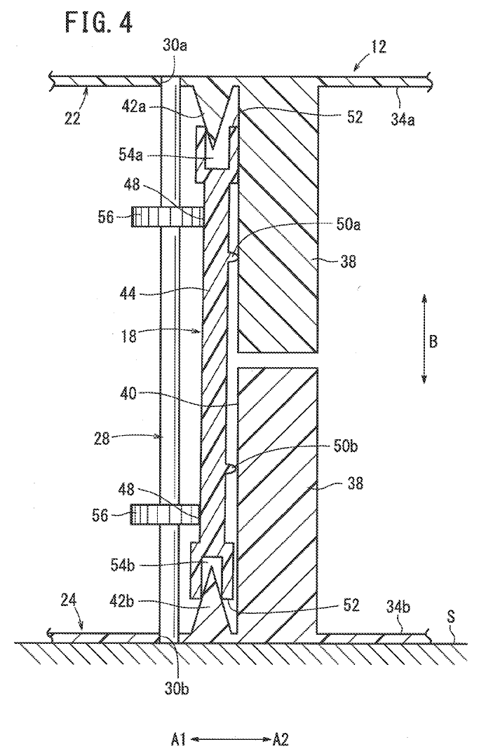

The guide members 42a, 42b are formed to bulge outwardly with arcuate shapes in cross section with a large radius of curvature (see FIG. 1) toward the side of the heater core 16 (in the direction of the arrow A2). Also, as shown in FIG. 4, the guide members 42a, 42b project with respect to the inner wall surfaces 34a, 34b at predetermined heights in the lateral direction of the casing 12 (the direction of the arrow B), and are formed in tapered shapes, which taper gradually in directions away from the inner wall surfaces 34a, 34b.

Stated otherwise, the guide members 42a, 42b are formed such that the thickness dimension thereof becomes gradually smaller in directions away from the inner wall surfaces 34a, 34b of the casing 12 (see FIG. 4).

Further, the guide members 42a, 42b are formed with a substantially constant height along a direction of extension thereof, which corresponds to the displacement direction of the air mixing damper 18.

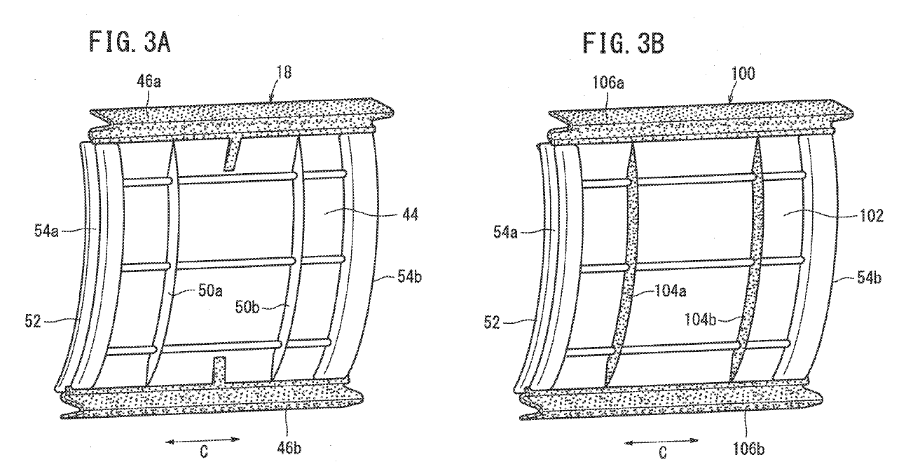

The air mixing damper 18 is disposed along the lateral direction of the casing 12 (in the direction of the arrow B in FIG. 4), and opposite sides thereof are guided along the pair of guide members 42a, 42b, which are disposed on the inner wall surfaces 34a, 34b of the first and second divided casings 22, 24. As shown in FIG. 3A, the air mixing damper is a plate, which is arcuate in cross section and formed with a large radius of curvature, and is formed in a convex shape in a direction away from the evaporator 14, i.e., so as to bulge convexly toward the side of the heater core 16 (in the direction of the arrow A2 in FIG. 1). Further, the air mixing damper 18 is formed with the same radius of curvature as the guide members 42a, 42b (see FIG. 1).

As shown in FIG. 3A, the air mixing damper 18 is constituted from a door main body 44 formed, for example, from a resin material, and the seal members 46a, 46b formed on ends of the door main body 44. After the door main body 44 is formed from a resin material such as polypropylene or the like, formation by casting or pouring is carried out on peripheral edge portions of the door main body 44 using a resilient material (e.g., an elastic material) having elasticity, whereby the air mixing damper 18 is formed by two-color molding. More specifically, the air mixing damper 18 is formed integrally by two-color molding from different materials for the door main body 44, which is formed from a resin material, and the seal members 46a, 46b, which are formed from an elastic material.

A pair of rack gears 48 is provided along the inner circumferential surface, which is recessed in a concave shape, of the door main body 44, and the plural ribs 50a, 50b also are provided on the door main body 44. On the inner circumferential surface of the door main body 44, the rack gears 48 are formed in straight line shapes, respectively, along the sliding direction of the air mixing damper 18, the rack gears 48 being disposed in the vicinity of opposite end portions in a lateral direction (the direction of the arrow C in FIG. 3A) perpendicular to the sliding direction. More specifically, the pair of rack gears 48 are disposed in parallel and are separated by a predetermined distance in the lateral direction (the direction of the arrow C) of the door main body 44.

The ribs 50a, 50b are formed on the door main body 44 on the outer circumferential surface thereof, which bulges convexly. The ribs 50a, 50b are formed substantially in parallel with the rack gears 48, and at positions on the lateral inward side of the door main body 44 (see FIG. 4). The ribs 50a, 50b are formed to project at a predetermined height with respect to the outer circumferential surface of the door main body 44. Further, the height of the ribs 50a, 50b is substantially constant along the sliding direction of the air mixing damper 18.

On the other hand, on both end portions 52 in the lateral direction (the direction of the arrow C) of the door main body 44, guide grooves (engagement members) 54a, 54b are formed, respectively, which open toward the outer sides with U-shapes in cross section (see FIG. 4). In addition, the guide members 42a, 42b of the first and second divided casings 22, 24 are inserted respectively into the guide grooves 54a, 54b, so that the air mixing damper 18 including the door main body 44 can be guided by the guide members 42a, 42b.

Instead of forming the guide members 42a, 42b of the first and second divided casings 22, 24 in tapered shapes, the aforementioned guide grooves 54a, 54b may be formed with tapered shapes, which taper gradually in directions away from the openings thereof (i.e., toward lateral inward sides of the door main body 44).

The seal members 46a, 46b are formed, for example, with triangular shapes in cross sections, and are formed on the door main body 44 on opposite ends, respectively, along the sliding direction of the air mixing damper 18. Additionally, the seal members 46a, 46b are formed to project at a predetermined height with respect to the outer circumferential surface of the door main body 44 on which the ribs 50a, 50b are formed. The height at which the seal members 46a, 46b project with respect to the outer circumferential surface is set to be higher than the height at which the ribs 50a, 50b project. Stated otherwise, the height of the ribs 50a, 50b in the thicknesswise direction of the air mixing damper 18 is lower than the height of the seal members 46a, 46b.

The driving force transmission mechanism 20 includes a plurality of gears that vary the speed and transfer the driving force of a drive source such as a stepping motor or the like, for example, and includes the shaft 28 held in meshed engagement with the gears, which transfers the driving force to the air mixing damper 18.

The shaft 28 further includes pinion gears 56 having gear teeth engraved on the outer circumferential surface thereof, and which are enmeshed with the rack gears 48 of the air mixing damper 18, and cylindrically shaped second tubular members 58, which project in an axial direction from the pinion gears 56 on opposite ends of the shaft 28. The second tubular members 58 are formed with substantially the same diameter as the insertion holes 30a, 30b, and are inserted into interior portions of the first tubular members 32a, 32b and the insertion holes 30a, 30b (see FIG. 2).

An input gear (not shown), which is enmeshed with a gear formed on a non-illustrated link arm, is formed in the second tubular member 58 on one end or the other end of the shaft 28. The shaft 28 is rotated through a predetermined angle as a result of the link arm being rotated by the aforementioned drive source.

Further, as shown in FIG. 2, annular grooves 60 are formed on the outer circumferential side with respect to the second tubular members 58, at junctions between the second tubular members 58 and the pinion gears 56, and the small diameter parts 36a, 36b of the first tubular members 32a, 32b, which are formed in the casing 12, are inserted respectively into the annular grooves 60. Owing thereto, the shaft 28 can be assembled coaxially with respect to the insertion holes 30a, 30b of the casing 12.

Further, a structure has been described above in which the aforementioned air mixing damper 18 is formed by molding the door main body 44 including the ribs 50a, 50b from a resin material, and the seal members 46a, 46b, which are formed on peripheral edge portions of the door main body 44, are molded integrally therewith from an elastic material, which differs from the aforementioned resin material. However, the invention is not limited to this structure.

For example, as an air mixing damper 100 shown in FIG. 3B, ribs 104a, 104b that are formed on a door main body 102 can be molded from an elastic material together with seal members 106a, 106b, such that the ribs 104a, 104b also are formed from a material that differs from that of the door main body 102. More specifically, first, after the door main body 102 is molded from a resin material, the ribs 104a, 104b and the seal members 106a, 106b are molded integrally with the door main body 102 by filling an elastic material with respect to peripheral edge portions of the door main body 102 and side surfaces of the door main body 102.

As a result of such a structure, the manufacturing cost of the air mixing damper 100 can be reduced.

The vehicular air conditioner 10 according to the present embodiment is constructed basically as described above. Next, an explanation shall be given concerning assembly of the first and second divided casings 22, 24 of the vehicular air conditioner 10. A condition shall be considered in which the evaporator 14 and the heater core 16 are assembled beforehand in the casing 12 of the vehicular air conditioner 10.

At first, as shown in FIG. 4, in a state in which the first and second divided casings 22, 24 that constitute the casing 12 are separated from each other, for example, the second divided casing 24 is placed on a floor surface S. In this case, the second divided casing 24 is arranged such that the interior thereof opens in an upward direction.

Next, the air mixing damper 18 is inserted into the interior of the second divided casing 24, such that the outer circumferential surface on which the ribs 50a, 50b are formed is arranged on the side of the heater core 16 (the side of the dividing wall 38), whereas the inner circumferential surface on which the rack gears 48 are disposed is arranged on the side of the evaporator 14 (in the direction of the arrow A1), and the guide member 42b is inserted into the guide groove 54b formed on the lateral end portion 52 thereof. At this time, since the end of the guide member 42b is formed in a tapered shape, the guide member 42b can be inserted easily and reliably into the guide groove 54b. As a result, the one lateral end portion 52 on the air mixing damper 18 is retained by the guide member 42b.

Further, the air mixing damper 18 is arranged substantially centrally along the direction in which the guide members 42a, 42b extend, so that the ribs 50a, 50b thereof abut against the sealing surface 40 of the dividing wall 38.

Next, one end of the shaft 28 is inserted into the insertion hole 30b of the second divided casing 24, such that a state is brought about in which the shaft 28 is substantially perpendicular with respect to the floor surface S. In this case, as shown in FIG. 2, the shaft 28 is assembled and retained substantially on the same axis by insertion of the second tubular member 58 provided on the end thereof into the first tubular member 32b of the casing 12, while in addition, by insertion of the small diameter part 36b of the first tubular member 32b into the annular groove 60 of the shaft 28, the shaft 28 can be retained rotatably on the same axis reliably and with high accuracy. Also, the pinion gears 56 of the shaft 28 are placed in meshed engagement with the rack gears 48 of the air mixing damper 18.

Consequently, by arranging the air mixing damper 18 between the dividing wall 38 and the shaft 28, falling over (tilting) of the air mixing damper 18 by more than a prescribed amount is prevented by the dividing wall 38 and the shaft 28, and the air mixing damper 18 is retained in a substantially upstanding fashion with respect to the inner wall surface 34b of the second divided casing 24. More specifically, the air mixing damper 18 is provisionally assembled in a roughly upstanding state with respect to the inner wall surface 34b of the second divided casing 24, for example, without requiring a worker to hold the air mixing damper 18 in place.

In addition, finally, the first divided casing 22 is assembled from an upward portion of the second divided casing 24. At this time, with the opening of the first divided casing 22 being oriented in a downward direction, i.e., toward the second divided casing 24, the first divided casing 22 is brought into proximity (downwardly) toward the side of the second divided casing 24. As a result, at first, the second tubular member 58 on the other end of the shaft 28 is inserted gradually into the insertion hole 30a of the first divided casing 22, whereupon the guide member 42a formed on the first divided casing 22 is inserted progressively into the guide groove 54a that is formed on the other lateral end portion 52 of the air mixing damper 18.

Further, in this case, because the guide member 42a of the first divided casing 22 is formed in a tapered shape that tapers gradually toward the side of the second divided casing 24, for example, even if the air mixing damper 18 is tilted somewhat, the guide member 42a can be inserted easily with respect to the guide groove 54a, whereby the air mixing damper 18 is corrected in position and assembled therein at a predetermined position (proper position).

Furthermore, as shown in FIG. 2, the second tubular member 58 on the other end of the shaft 28 is inserted into the insertion hole 30a and the first tubular member 32a of the first divided casing 22, while in addition, the small diameter part 36a is inserted into the annular groove 60. Consequently, the shaft 28 is retained rotatably on the same axis with respect to the insertion hole 30a of the first divided casing 22. Further, the shaft 28 may be fixed temporarily by a non-illustrated jig or the like, so as to remain in an upstanding posture with respect to the inner wall surface 34b of the second divided casing 24.

In addition, by overlapping the open end of the first divided casing 22 on the open end of the second divided casing 24, and by mutually fixing the first divided casing 22 and the second divided casing 24 together by a non-illustrated fixing means (fixing bolts or the like), assembly of the air mixing damper 18 with respect to the vehicular air conditioner 10 is completed.

Further, on the assembled air mixing damper 18, the ribs 50a, 50b thereof are disposed so as to be separated slightly with respect to the sealing surface 40 of the dividing wall 38 (see FIG. 1). Consequently, sliding resistance is suppressed when the air mixing damper 18 is moved along the guide members 42a, 42b, so that the air mixing damper 18 can be displaced smoothly.

In the foregoing manner, with the present embodiment, the guide grooves 54a, 54b are formed respectively on the lateral end portions 52 of the door main body 44 that makes up the air mixing damper 18, whereas on the inner wall surfaces 34a, 34b of the first and second divided casings 22, 24 that confront the guide grooves 54a, 54b, the pair of guide members 42a, 42b are formed, which project from the inner wall surfaces 34a, 34b. Also, the guide members 42a, 42b are formed in tapered shapes tapering in directions away from the inner wall surfaces 34a, 34b.

Owing thereto, when the air mixing damper 18 is assembled with respect to the first and second divided casings 22, 24, the guide members 42a, 42b can be easily inserted with respect to the guide grooves 54a, 54b, while in addition, even if the air mixing damper 18 becomes tilted with respect to the casing 12, the position thereof can be corrected to a predetermined position (proper position) established beforehand.

As a result, for example, when the first divided casing 22 and the second divided casing 24 are assembled together, assembly thereof can be carried out reliably and effectively without the need for a worker to support the air mixing damper 18.

Further, on the outer circumferential surface of the door main body 44 that constitutes the air mixing damper 18, the ribs 50a, 50b are provided, which project from the outer circumferential surface and extend along the direction of movement of the air mixing damper 18. As a result, when the air mixing damper 18 is assembled in the interior of the first and second divided casings 22, 24, which are divided into two parts, for example, in a condition in which the ribs 50a, 50b abut against the sealing surface 40 of the dividing wall 38 in the first and second divided casings 22, 24, the pinion gears 56 of the shaft 28 are placed in meshed engagement with the rack gears 48 of the air mixing damper 18, whereby inclination of the air mixing damper 18 can be suppressed.

For this reason, by assembling the first divided casing 22 with respect to the second divided casing 24 in which the air mixing damper 18 has been provisionally fitted therein, the air mixing damper 18 can reliably and efficiently be assembled with respect to the first and second divided casings 22, 24.

Furthermore, on the air mixing damper 18, the door main body 44 is molded, for example, from a resin material, and after formation of the door main body 44, the seal members 46a, 46b are formed by casting or pouring an elastic material on peripheral edge portions of the door main body 44, whereby the air mixing damper 18 is formed integrally by two-color molding. Thus, manufacturing costs for the air mixing damper 18 can be reduced.

Still further, the ribs 50a, 50b are disposed so as to project partially with respect to the outer circumferential surface of the door main body 44. Therefore, when the air mixing damper 18 is displaced slidably in the interior of the casing 12, for example, even if the ribs 50a, 50b come into abutment against the sealing surface 40 of the dividing wall 38, compared to a case in which the outer circumferential surface abuts entirely against the sealing surface 40, sliding resistance of the air mixing damper 18 can be suppressed. More specifically, by minimizing the contact area between the air mixing damper 18 and the sealing surface 40, sliding resistance can be suppressed.

Still further, the ribs 50a, 50b provided on the door main body 44 are formed so as to project at a lower height than the height at which the seal members 46a, 46b project. Therefore, by abutment of the seal members 46a, 46b reliably against the dividing wall 38, flowing of air through the passage can be blocked, while in addition, it is less likely for the ribs 50a, 50b to come into contact with the sealing surface 40 of the dividing wall 38.

Further, by forming the ribs 50a, 50b from an elastic material, even if the ribs 50a, 50b do come into contact with the sealing surface 40 of the dividing wall 38, since the hardness thereof is low in comparison with the sealing surface 40, damage to the sealing surface 40 can be prevented. In addition, as a result of the door main body 44 being urged by the elastic force of the ribs 50a, 50b toward the side of the shaft 28, the enmeshed condition of the rack gears 48 and the shaft 28 can be enhanced favorably.

Next, operations of the vehicular air conditioner 10 in which the above described air mixing damper 18 is assembled shall briefly be described.

First, a non-illustrated vehicle occupant, by operating an operating lever positioned inside the vehicle cabin in which the vehicular air conditioner 10 is installed, causes a non-illustrated drive source to be driven rotatably responsive to the operation of the operating lever. Through a plurality of gears and a link arm, the driving force of the drive source is transmitted to the shaft 28, whereby the shaft 28 is rotated through a predetermined angle. Thus, the air mixing damper 18 with which the pinion gears 56 of the shaft 28 are enmeshed is displaced slidably by a predetermined distance upwardly or downwardly while being guided by the pair of guide members 42a, 42b. As a result, by displacement of the air mixing damper 18, the flow through state of air in the flow passage in the interior of the casing 12 is controlled, and the airflow rate and air temperature of air supplied from the flow passage into the cabin interior is controlled.

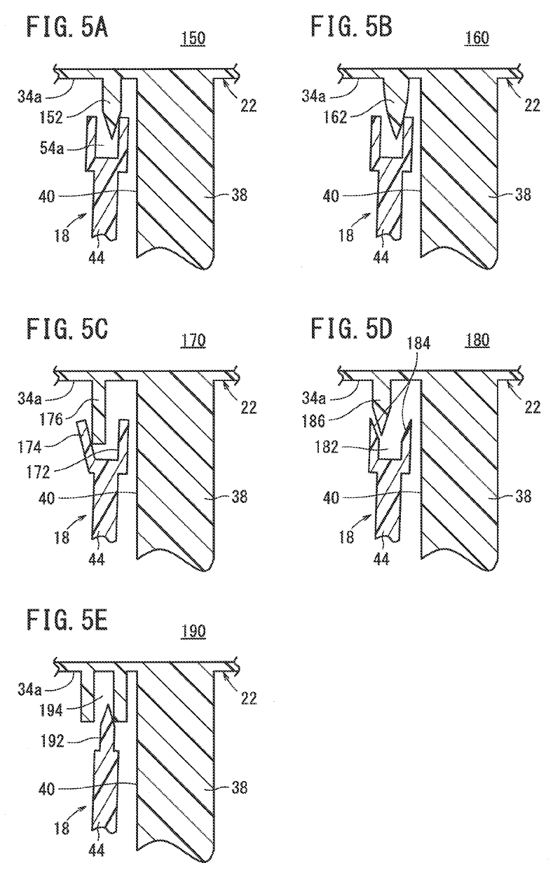

Further, the aforementioned guide members 42a, 42b are not limited to being formed in tapered shapes that taper from the inner wall surfaces 34a, 34b of the casing 12 toward the distal ends thereof. For example, as in a vehicular air conditioner 150 according to a first modification shown in FIG. 5A, guide members 152 may be provided in which only the distal ends thereof are tapered, whereas the region from the distal ends to the inner wall surfaces 34a, 34b of the casing 12 may be formed at a constant diameter. Further, as in a vehicular air conditioner 160 according to a second modification shown in FIG. 5B, guide members 162 may be provided that bulge outwardly with a curved shape in cross section toward the outer circumferential side thereof, and wherein the guide members 162 are gradually reduced in diameter toward the distal ends. More specifically, by forming the distal ends of the guide members 152, 162 in a tapered manner, the guide members 152, 162 can easily be inserted with respect to the guide grooves 54a, 54b of the air mixing damper 18.

On the other hand, the guide grooves 54a, 54b of the air mixing damper 18 are not limited to being formed with the same thickness and with a substantially uniform width dimension along the lateral direction of the door main body 44. For example, as in a vehicular air conditioner 170 according to a third modification shown in FIG. 5C, one wall portion 174 in guide grooves 172 may be inclined so as to expand in width toward the side of guide members 176. Further, as in a vehicular air conditioner 180 according to a fourth modification shown in FIG. 5D, inner wall surfaces 184 of guide grooves 182 may be formed in a tapered shape so as to expand in width toward the side of guide members 186. In this case, the distal ends of the guide members 186 also are tapered. As a result of such structures, when the guide members 176, 186 are inserted with respect to the guide grooves 172, 182, insertion thereof can be accomplished more easily and reliably.

Furthermore, instead of forming the guide grooves 54a, 54b in concave shapes on side portions of the air mixing damper 18, and providing convexly shaped guide members 42a, 42b on the inner wall surfaces 34a, 34b of the casing 12 confronting the guide grooves 54a, 54b as was described above, as in a vehicular air conditioner 190 according to a fourth modification shown in FIG. 5E, a structure may be provided in which convexly shaped guide members 192 are provided on side portions of the air mixing damper 18, whereas concave guide grooves 194 are disposed on the inner wall surfaces 34a, 34b of the casing 12, such that the guide members 192 are inserted with respect to the guide grooves 194.

More specifically, as in the aforementioned first through fifth modifications, among the mutually inserted and engaged guide members 152, 162, 176, 186, 192 and guide grooves 172, 182, 194, by forming at least one of the distal ends thereof to be tapered in shape or expanded in width, the insertion and engagement operations of both members can be carried out with greater ease.

The vehicular air conditioner according to the present invention is not limited to the aforementioned embodiment, and it is a matter of course that various additional or modified structures may be adopted therein without deviating from the essential gist of the present invention.

What is claimed is:

1. A vehicular air conditioner including a casing having an air flow passage in an interior thereof, and a slide mechanism disposed movably in the interior of the casing, for switching a communication state of the air flow passage by moving in a direction to block the air flow passage,
the casing being formed in a dividable fashion in a lateral direction perpendicular to a displacement direction of the slide mechanism,
the casing comprising:
a guide member that engages with the slide mechanism for guiding the slide mechanism; and
a seat section that abuts against a downstream side of the slide mechanism for blocking communication between upstream and downstream sides of the air flow passage; and
the slide mechanism comprising:
a door main body that blocks the air flow passage by abutment against the seat section;
a shaft disposed rotatably in the casing and which is disposed on an upstream side of the door main body for thereby driving the door main body; and
an engagement member, which is disposed on a lateral end portion on the door main body, and is engaged with the guide member,
wherein at least one of the guide member and the engagement member includes a correcting member for correcting an inclination of the door main body toward a seal member to a proper position.

2. The vehicular air conditioner according to claim 1, wherein one of the guide member and the engagement member has a recess therein that opens toward another one of the guide member and the engagement member, and the other one of the guide member and the engagement member has a projection that is inserted into the recess, the correcting member comprising an inclined surface, which is inclined toward an end of the projection.

3. The vehicular air conditioner according to claim 1, wherein one of the guide member and the engagement member has a recess therein that opens toward another one of the guide member and the engagement member, and the other one of the guide member and the engagement member has a projection that is inserted into the recess, the correcting member comprising an inclined surface, which is inclined such that an opening side of the recess is wider than a bottom side of the recess.

4. The vehicular air conditioner according to claim 1, wherein a falling over prevention member, which projects toward the seat section for preventing falling over of the door main body at a time that the casing is assembled, is formed on the door main body.

5. The vehicular air conditioner according to claim 4, wherein the failing over prevention member comprises a rib that extends along a direction of movement of the door main body and projects from a side surface of the door main body.

6. The vehicular air conditioner according to claim 4, wherein the door main body is equipped with the seal member, which projects toward a side of the seat section on an end along a direction of movement of the door main body and abuts against the seat section, and wherein a height of the falling over prevention member in a thicknesswise direction of the door main body is lower than a height of the seal member.

7. The vehicular air conditioner according to claim 5, wherein the falling over prevention member is formed from an elastic material.

8. The vehicular air conditioner according to claim 7, wherein the falling over prevention member is formed by integral molding with the seal member.

9. The vehicular air conditioner according to claim 1, the casing further comprising:
an insertion hole in which the shaft is inserted; and
an insertion tubular member formed around a periphery of the insertion hole and which extends in an axial direction of the shaft,
wherein the shaft includes an annular groove in which the insertion tubular member is inserted on an end thereof confronting the casing.

10. An assembly method for a vehicular air conditioner including casings having an air flow passage in an interior thereof and capable of being divided in a lateral direction, and a slide damper disposed movably in the interior of the casings for switching a communication state of the air flow passage by moving in a direction to block the air flow passage, the assembly method comprising the steps of:
when the slide damper is to be assembled in the casings, engaging the slide damper with a divided one of the casings;
fixing a shaft in an upright manner with respect to the one casing, and arranging the slide damper between the shaft and a seat section which is formed in the one casing and which blocks communication between upstream and downstream sides of the air flow passage; and
while the slide damper is supported by the seat section and the shaft, assembling another of the casings together with the one casing.

11. The assembly method according to claim 10, further comprising the step of, after the slide damper has been placed in engagement with the one casing, causing a side surface of the slide damper to abut against the seat section.
